(19) United States
(12) Patent Application Publication
(10) Pub. No.: US 2017/0094303 A1
(43) Pub. Date: Mar. 30, 2017

(54) METHOD AND DEVICE FOR ENCODING/DECODING MOTION MERGING CANDIDATE USING DEPTH INFORMATION

(71) Applicant: INTELLECTUAL DISCOVERY CO., LTD., Seoul (KR)

(72) Inventors: Gwang Hoon PARK, Seongnam-si (KR); Yoon Jin LEE, Yongin-si (KR)

(73) Assignee: INTELLECTUAL DISCOVERY CO., LTD., Seoul (KR)

(21) Appl. No.: 15/126,106

(22) PCT Filed: Jan. 15, 2015
(86) PCT No.: PCT/KR2015/000451

§ 371 Date: Sep. 14, 2016

(30) Foreign Application Priority Data
Mar. 31, 2014 (KR) 10-2014-0038098

(51) Int. Cl. H04N 19/51; H04N 19/61; H04N 19/124; H04N 19/46

(52) U.S. Cl. CPC H04N 19/51; H04N 19/46; H04N 19/61; H04N 19/124; H04N 19/176

(57) ABSTRACT

The present invention provides a method and a device for encoding a motion merge candidate using depth information. A method for encoding a motion merge candidate using depth information, according to an embodiment of the present invention, comprises the steps of: determining a first condition with respect to whether or not a current block and an neighboring block that is spatially adjacent to the current block exist in the same object area, in which depth information is used for determining; determining a second condition with respect to whether or not a motion merge candidate of the current block and a motion merge candidate of the neighboring block are the same; and, if the first condition and the second condition are satisfied, instead of encoding the motion merge candidate of the current block, encoding flag information which indicates that the motion merge candidate of the current block and the motion merge candidate of the neighboring block are the same.

### TECHNICAL FIELD

The present invention relates, in general, to a method and device for encoding/decoding a motion merge candidate using depth information and, more particularly, to a method for deriving a motion merge candidate using the encoded information of a reference block in order to derive a motion merge candidate for a current block.

### BACKGROUND ART

Recently, with the demand for video service having a high-quality video mode such as Full High Definition (FHD) or Ultra High Definition (UHD), the requirement for next-generation video coding standards has increased. The International Organization for Standardization (ISO)/International Electrotechnical Commission (IEC) Moving Picture Experts Group (MPEG) and the Telecommunication Standardization Sector of the International Telecommunications Union (ITU-T) Video Coding Experts Group (VCEG) organized a Joint Collaborative Team on Video Coding (JCT-VC), and worked on the High Efficiency Video Coding (HEVC) standard as a new video coding standard with the aim of doubling the coding efficiency of H.264/AVC. The development of standard technology for HEVC version 1 was completed in January 2013, and since then, HEVC Range Extension standards for supporting various color formats and bit depths have been under development.

HEVC employs various techniques in consideration not only of encoding efficiency but also of various encoding/decoding procedures required in next-generation video standards. For example, HEVC includes technology such as a tile, which is a new unit for partitioning a picture in consideration of the parallelism of encoding/decoding processes, and a Merge Estimation Region (MER) for ensuring the parallelism of decoding based on Prediction Units (PU). Particularly, in response to market demand for high definition and high quality, HEVC employs techniques such as a deblocking filter, a Sample Adaptive Offset (SAO), and a scaling list in order to improve subjective image quality. However, according to HEVC, because the insertion of additional bits is required when motion information is derived, it is necessary to encode or decode motion information more effectively by minimizing the number of additional bits.

Meanwhile, Korean Patent Application Publication No. 10-2011-0137042, titled “Method for inter prediction and apparatus thereof” discloses deriving reference motion information for a unit to be decoded in a current picture and performing motion compensation for the unit to be decoded.

### DISCLOSURE

### Technical Problem

The present invention intends to solve the above-mentioned problems occurring in the conventional art, and an object of some embodiments of the present invention is to propose a method and device for effectively coding motion information using the fact that blocks within the same object tend to have the same motion information as the motion information resulting from analyzing blocks that are coded through a motion merge prediction mode as the result of performing High Efficiency Video Coding (HEVC) on a video.

However, the technical object intended to be accomplished by the present embodiments is not limited to the above-described technical object, and other technical objects may be present.

### Technical Solution

As a technical solution for accomplishing the above object, a method for coding a motion merge candidate using depth information according to an embodiment of the present invention includes determining a first condition corresponding to whether a current block and a neighboring block, which is spatially adjacent to the current block, are present in an identical object area, the first condition being determined using the depth information; determining a second condition corresponding to whether a motion merge candidate of the current block is identical to a motion merge candidate of the neighboring block; and when the first condition and the second condition are satisfied, coding flag information that represents that the motion merge candidate of the current block is identical to the motion merge candidate of the neighboring block, rather than coding the motion merge candidate of the current block.

Also, a device for coding a motion merge candidate using depth information according to an embodiment of the present invention includes a depth information extraction unit for extracting depth information from a current block and a neighboring block, which is adjacent to the current block; an object area comparison unit for determining a first condition corresponding to whether the current block and the neighboring block are present in an identical object area based on the depth information extracted by the depth information extraction unit; a motion merge candidate comparison unit for determining a second condition corresponding to whether a motion merge candidate of the current block is identical to a motion merge candidate of the neighboring block; a flag information generation unit for generating flag information based on at least one of a result of the determination by the object area comparison unit and a result of the determination by the motion merge candidate comparison unit; and a coding unit for coding at least one of the motion merge candidate of the current block and the flag information.

Also, the method for coding a motion merge candidate using depth information according to an embodiment of the present invention may further include determining a third condition corresponding to whether a motion merge candidate of a first neighboring block is identical to a motion merge candidate of a second neighboring block, the first neighboring block and the second neighboring block being adjacent to the current block. Here, when the third condition is satisfied, the first condition and the second condition are determined, and when the first condition, the second condition, and the third condition are satisfied, coding the flag information may be configured to perform coding of the flag information.

Also, the first neighboring block may be an upper block relative to the current block, and the second neighboring block may be a left block relative to the current block.

Also, at least one of the first neighboring block and the second neighboring block may be a skip block.

Also, the method for coding a motion merge candidate may further include, when the third condition is not satisfied, coding the motion merge candidate of the current block.

Also, the method for coding a motion merge candidate may further include, when the first condition or the second condition is not satisfied, coding the flag information to 0 and coding the motion merge candidate of the current block.

Also, the determining the first condition using the depth information may include performing labeling of an object area in which the current block is present and labeling of an object area in which the neighboring block is present by analyzing depth information acquired using a depth camera, and the first condition may be determined based on the labeling.

The object area comparison unit may perform labeling of an object area in which the current block is present and labeling of an object area in which the neighboring block is present by analyzing depth information acquired using a depth camera, and may determine the first condition based on the labeling.

Also, the motion merge candidate comparison unit may determine a third condition corresponding to whether a motion merge candidate of a first neighboring block is identical to a motion merge candidate of a second neighboring block, the first neighboring block and the second neighboring block being adjacent to the current block.

Here, the first neighboring block may be an upper block relative to the current block, and the second neighboring block may be a left block relative to the current block.

Also, at least one of the first neighboring block and the second neighboring block may be a skip block.

Also, when the first condition or the second condition is not satisfied, the coding unit may code the flag information to 0 and code the motion merge candidate of the current block.

Also, when the third condition is satisfied, the object area comparison unit may determine the first condition and the motion merge candidate comparison unit may determine the second condition, and when the first condition, the second condition, and the third condition are satisfied, the coding unit may perform coding of flag information that represents that the motion merge candidate of the current block is identical to the motion merge candidate of the neighboring block, rather than coding the motion merge candidate of the current block.

Here, when the third condition is not satisfied, the coding unit may perform coding of the motion merge candidate of the current block.

### Advantageous Effects

According to the above-mentioned technical solutions of the present invention, the present invention determines an object area based on depth information, and may encode at least one of a motion merge candidate and flag information based on the result of the determination, whereby encoding and decoding efficiency may be improved.

Also, the present invention may indirectly determine whether the current block and a neighboring block are included in the same object area based on flag information even if depth information is not directly encoded and decoded, whereby overall encoding and decoding efficiency may be improved.

Also, the present invention may infer object information by sharing flag information using depth information, and may set an object area that includes each block.

### DESCRIPTION OF DRAWINGS

FIG. 1 is a block diagram illustrating an example of a video encoder;

FIG. 2 is a block diagram illustrating an example of a video decoder;

FIG. 3 is a block diagram of a device for coding a motion merge candidate using depth information according to an embodiment of the present invention;

FIG. 4 illustrates a skip block analyzed after coding is performed in the same object area;

FIG. 5 illustrates a neighboring block that is spatially adjacent to the current block in the same object area;

FIG. 6 is a flowchart of a method for coding a motion merge candidate using depth information according to an embodiment of the present invention; and

FIG. 7 is a flowchart of a method for coding a motion merge candidate using depth information according to another embodiment of the present invention.

### BEST MODE

Embodiments of the present invention are described with reference to the accompanying drawings in order to describe the present invention in detail so that those having ordinary knowledge in the technical field to which the present invention pertains can easily practice the present invention. However, the present invention may be implemented in various forms, and is not limited by the following embodiments. In the drawings, the illustration of components that are not directly related to the present invention will be omitted, for clear description of the present invention, and the same reference numerals are used to designate the same or similar elements throughout the drawings.

Further, throughout the entire specification, it should be understood that a representation indicating that a first component is “connected” to a second component may include the case where the first component is electrically connected to the second component with some other component interposed therebetween, as well as the case where the first component is “directly connected” to the second component. Furthermore, it should be understood that a representation indicating that a first component “includes” a second component means that other components may be further included, without excluding the possibility that other components will be added, unless a description to the contrary is specifically pointed out in context.

It will be understood that when an element is referred to as being “on” another element, it can be directly on the other element or intervening elements may be present therebetween.

Detailed embodiments of the present invention will be described in detail with reference to the attached drawings. However, the spirit of the present invention is not limited to the presented embodiments, and other embodiments may be easily devised via the addition, modification, deletion or insertion of components within the scope of the same spirit as that of the present invention, and it may be understood that the other embodiments may also be included in the scope of the present invention.

Throughout the present specification, a representation indicating that a first component “includes” a second component means that other components may be further included, without excluding the possibility that other components will be added, unless a description to the contrary is specifically pointed out in context. The term “step of performing ˜” or “step of ˜” used throughout the present specification does not mean “step for ˜”.

Hereinafter, a preferred embodiment of the present invention will be described in detail with reference to the accompanying drawings.

Further, all of the methods and devices disclosed in the embodiments of the present invention may be applied both to encoding and decoding procedures performed in a video processing procedure, and the term ‘coding’ used throughout the present specification is a higher concept including both encoding and decoding procedures.

Here, ‘encoding’ means a procedure for transforming the form or format of video into another form or format for standardization, security, compression, or the like. Further, ‘decoding’ means a conversion procedure for restoring the form or format of encoded video to its original form or format before it was encoded.

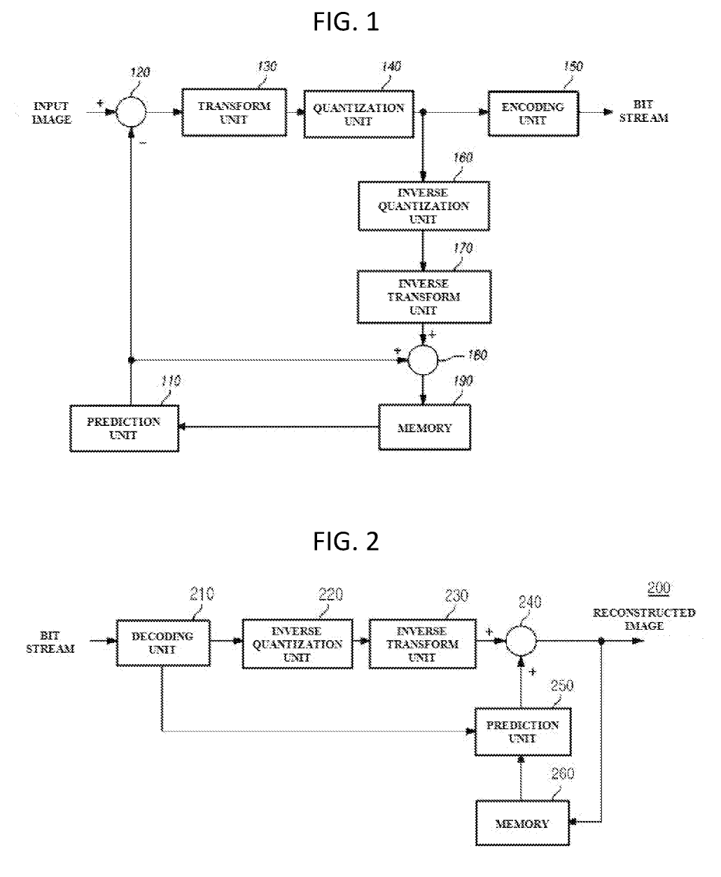

Next, an encoder 100 and a decoder 200 will be described with reference to FIG. 1 and FIG. 2.

FIG. 1 is a block diagram showing an example of a video encoder 100.

Referring to FIG. 1, the video encoder 100 may include a prediction unit 110, a subtractor 120, a transform unit 130, a quantization unit 140, an encoding unit 150, an inverse quantization unit 160, an inverse transform unit 170, an adder 180, and memory 190.

The prediction unit 110 generates a predicted block by predicting the current block, which is desired to be currently encoded in video. That is, the prediction unit 110 may generate a predicted block having predicted pixel values from the pixel values of respective pixels in the current block depending on motion information that is determined based on motion estimation. Further, the prediction unit 110 may transfer information about a prediction mode to the encoding unit so that the encoding unit 150 encodes information about the prediction mode.

The subtractor 120 may generate a residual block by subtracting the predicted block from the current block.

Further, the transform unit 130 may transform respective pixel values of the residual block into frequency coefficients by transforming the residual block into a frequency domain. For example, the transform unit 130 may transform a video signal in a time domain into a video signal in a frequency domain based on a transform method such as a Hadamard transform or a discrete cosine transform-based transform.

The quantization unit 140 may quantize the residual block transformed into the frequency domain by the transform unit 130.

Further, the encoding unit 150 may encode the quantized residual block based on a coding technique, and may then output a bitstream. Here, the coding technique may be an entropy coding technique. Further, the encoding unit 150 may also encode the information about the prediction mode of the current block, transferred from the prediction unit 110, together with the residual block.

The inverse quantization unit 160 may inversely quantize the residual block, which has been quantized by the quantization unit 140. That is, the inverse quantization unit 160 may transform the residual block, which has been transformed into the frequency domain, by inversely quantizing the quantized residual block in the frequency domain.

The inverse transform unit 170 may inversely transform the residual block, which has been inversely quantized by the inverse quantization unit 160. That is, the inverse transform unit 170 may reconstruct the residual block in the frequency domain as a residual block having pixel values. Here, the inverse transform unit 170 may use the transform method performed by the transform unit 130 by inversely performing the transform method.

The adder 180 may reconstruct the current block by adding the predicted block, generated by the prediction unit 110, to the residual block, which has been inversely transformed and reconstructed by the inverse transform unit 170. Further, the reconstructed current block is stored in the memory 190, and the reconstructed current block, which is stored in the memory 190, may be transferred to the prediction unit 110 and may be utilized to predict a subsequent block using the corresponding reference block.

Meanwhile, the video encoder 100 may further include a deblocking filter (not shown). The deblocking filter (not shown) may function to improve the video to realize higher-quality video before storing the current block, reconstructed by the adder 180, in the memory.

FIG. 2 is a block diagram showing an example of a video decoder 200.

Referring to FIG. 2, the video decoder 200 may extract a residual block and prediction mode information, which are present before being encoded by the video encoder 100, by decoding a bitstream. The video decoder 200 may include a decoding unit 210, an inverse quantization unit 220, an inverse transform unit 230, an adder 240, a prediction unit 250, and memory 260.

The decoding unit 210 may reconstruct an encoded residual block and encoded motion information for the current block from an input bitstream. That is, the decoding unit 210 may reconstruct a residual block, encoded based on a coding technique, as a quantized residual block. An example of the coding technique used by the decoding unit 210 may be an entropy coding technique.

The inverse quantization unit 220 may inversely quantize the quantized residual block. That is, the inverse quantization unit 220 may reconstruct the quantized residual block as a residual block transformed into the frequency domain by inversely quantizing the quantized residual block.

The inverse transform unit 230 may reconstruct the inversely quantized residual block, reconstructed by the inverse quantization unit 220, as the original residual block by inversely transforming the inversely quantized residual block. Here, the inverse transform unit 230 may perform an inverse transform by inversely performing a transform technique used by the transform unit 130 of the video encoder 100.

The prediction unit 240 may predict the current block and generate a predicted block based on the motion information of the current block, which is extracted from the bitstream and decoded and reconstructed by the decoding unit 210.

The adder 250 may reconstruct the current block by adding the predicted block to the reconstructed residual block. That is, the adder 250 may reconstruct the current block by adding predicted pixel values of the predicted block, which is output from the prediction unit 240, to the residual signal of the reconstructed residual block, which is output from the inverse transform unit 230, and then obtaining the reconstructed pixel values of the current block.

The current block, reconstructed by the adder 250, may be stored in the memory 260. Further, the stored current block may be stored as a reference block, and may be used by the prediction unit 240 to predict a subsequent block.

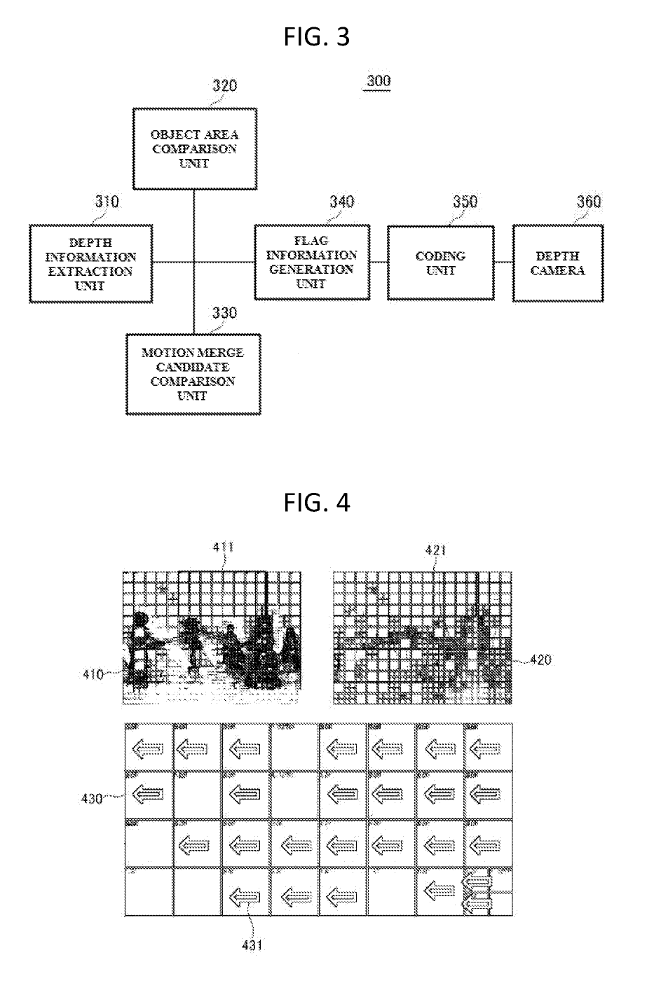

FIG. 3 is a block diagram of a device 300 for coding a motion merge candidate using depth information according to an embodiment of the present invention.

Referring to FIG. 1, a device 300 for coding a motion merge candidate according to an embodiment of the present invention may include a depth information extraction unit 310, an object area comparison unit 320, a motion merge candidate comparison unit 330, a flag information generation unit 340, and a coding unit 350.

In an embodiment, the depth information extraction unit 310 may extract depth information from a current block and a neighboring block, which is spatially adjacent to the current block.

The object area comparison unit 320 may determine a first condition corresponding to whether the current block and the neighboring block are included in the same object area based on the depth information extracted by the depth information extraction unit 310.

For example, the object area comparison unit 320 may perform labeling of the object area in which the current block is present and labeling of the object area in which the neighboring block is present by analyzing depth information acquired using a depth camera. The object area comparison unit 320 may determine the first condition based on the labeling.

The depth camera 360 for acquiring the depth information may be combined with or connected to the device 300 for coding a motion merge candidate using depth information, as part of the same device, or may be arranged as a separate device. Also, with technological advances, it may be variously manufactured without limitation as to the size or shape thereof.

The motion merge candidate comparison unit 330 may determine a second condition corresponding to whether the motion merge candidate of the current block is the same as the motion merge candidate of the neighboring block.

The flag information generation unit 340 may generate flag information based on at least one of the result of the determination by the object area comparison unit 320 and the result of the determination by the motion merge candidate comparison unit 330.

The coding unit 350 may perform at least one of coding of the motion merge candidate of the current block and setting of the flag information.

Specifically, when the first condition and the second condition are satisfied, the coding unit 350 may set the flag information representing that the motion merge candidate of the current block is the same as the motion merge candidate of the neighboring block, rather than coding the motion merge candidate of the current block.

For example, when the current block and the neighboring block are included in the same object area, and when the motion merge candidate of the current block is the same as that of the neighboring block, the coding unit 350 may not perform coding of the motion merge candidate of the current block. Instead, the coding unit 350 may set same_merge_flag to 1, which means TRUE, in the flag information.

Also, when the first condition or the second condition is not satisfied, the coding unit 350 sets flag information representing that the current block and the neighboring block are not present in the same object area or that the motion merge candidate of the current block is not the same as that of the neighboring block, and may perform coding of the motion merge candidate of the current block.

For example, when the current block and the neighboring block are not present in the same object area or when the motion merge candidate of the current block differs from that of the neighboring block, same_merge_flag may be set to 0, which means FALSE, in the flag information, and the motion merge candidate of the current block X3 may be coded.

Meanwhile, in another embodiment, the motion merge candidate comparison unit 330 may determine a third condition corresponding to whether the motion merge candidate of a first neighboring block is the same as that of a second neighboring block, the first and second neighboring blocks being adjacent to the current block.

Here, the first neighboring block may be the upper block relative to the current block, and the second neighboring block may be the left block relative to the current block.

Also, at least one of the first neighboring block and the second neighboring block, determined by the motion merge candidate comparison unit 330, may be a skip block. Here, the skip block may be a block that is present in the same object area and has the same motion merge candidate.

The flag information generation unit 340 may generate flag information based on at least one of the result of the determination by the object area comparison unit 320 and the result of the determination by the motion merge candidate comparison unit 330.

Additionally, when the third condition, determined by the motion merge candidate comparison unit 330, is satisfied, the object area comparison unit 320 may determine the first condition and the motion merge candidate comparison unit 330 may determine the second condition.

When the first, second, and third conditions are satisfied, the coding unit 350 may set the flag information representing that the motion merge candidate of the current block is the same as the motion merge candidate of the neighboring block, rather than coding the motion merge candidate of the current block.

For example, when the current block and the neighboring block are included in the same object area and when the motion merge candidate of the current block is the same as that of the neighboring block, the coding unit 350 may not perform coding of the motion merge candidate of the current block, but may set same_merge_flag to 1 in the flag information.

Also, when the third condition is not satisfied, the coding unit 350 may perform coding of the motion merge candidate of the current block.

FIG. 4 illustrates a skip block, analyzed after coding is performed in the same object area.

Referring to FIG. 4, the upper part of FIG. 4 shows a depth information image 420, which is acquired by coding an example image 410 that includes a predetermined area 411. Also, the lower part of FIG. 2 shows the result 430 of coding the area 421 corresponding to the predetermined area 411 in the depth information image.

Here, the arrows 431 depicted in the coding result 430 shown in the lower part of FIG. 2 represent skip blocks that have the same motion merge candidate. Here, it is confirmed that the skip blocks are coded in a group in the same object area.

Therefore, the device 300 for coding a motion merge candidate using depth information may share depth information in connection with the existing motion information using the characteristic whereby the same object area tends to have the same motion information. Also, thanks to this characteristic, the encoding and decoding efficiency of the device 300 for coding a motion merge candidate using depth information may be improved.

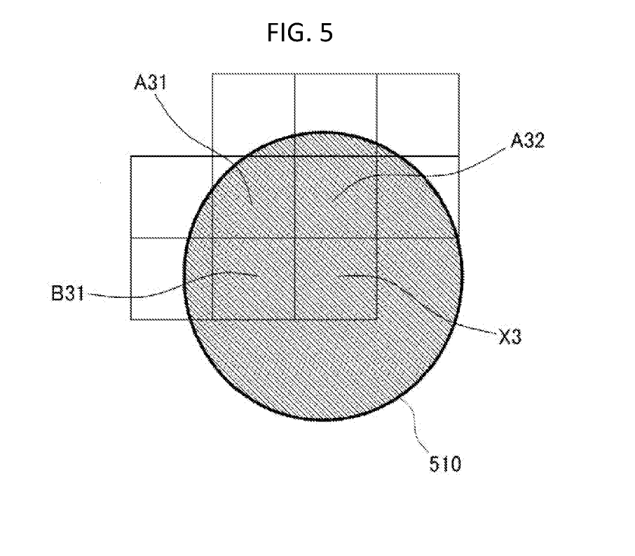

FIG. 5 illustrates a neighboring block that is spatially adjacent to the current block in the same object area.

Hereinafter, the current block, a neighboring block, and a description related thereto, proposed in the device 300 for coding a motion merge candidate using depth information according to an embodiment of the present invention, are described with reference to FIG. 5.

The current block X3 within the object area 510 and neighboring blocks A32 and B31, which are spatially adjacent to the current block X3, are present in the same object area 510. Here, when the motion merge candidate of the current block is the same as that of these neighboring blocks, the device 300 for coding a motion merge candidate using depth information does not perform coding of the motion merge candidate of the current block X3, but may set flag information representing that the motion merge candidate of the current block X3 is the same as that of the neighboring blocks A32 and B31.

For example, when the current block X3 and the neighboring blocks A32 and B31 are included in the same object area 510 and when the motion merge candidate of the current block X3 is the same as that of the neighboring blocks, the device 300 for coding a motion merge candidate using depth information does not perform coding of the motion merge candidate for the current block X3, but may set same_merge_flage to 1 in the flag information.

In another embodiment, if the current block X3 and the neighboring blocks A32 and B31 are not present in the same object area 510, or when the motion merge candidate of the current block X3 is different from that of the neighboring blocks A32 and B31, the device 300 for coding a motion merge candidate using depth information may set flag information and perform coding of the motion merge candidate of the current block X3. Here, the set flag information may include information representing that the current block X3 and the neighboring blocks A32 and B31 are not present in the same object area 510 or information representing that the motion merge candidate of the current block X3 is not the same as that of the neighboring blocks A32 and B31.

For example, when the current block X3 and the neighboring blocks A32 and B31 are not present in the same object area 510 or when the motion merge candidate of the current block X3 is different from that of the neighboring blocks A32 and B31, the device 300 for coding a motion merge candidate using depth information may set same_merge_flag to 0 in the flag information. Also, the device 100 for coding a motion merge candidate using depth information may perform coding of the motion merge candidate of the current block X3.

Accordingly, when encoding or decoding is performed, the present invention may infer the same object area as in the process for predicting a motion merge candidate, and may use depth information (or object information derived from the depth information) very efficiently.

Additionally, the device 300 for coding a motion merge candidate using depth information according to an embodiment of the present invention may be included in the video encoder 100 illustrated in FIG. 1 or the video decoder 200 illustrated in FIG. 2. For example, the device 300 for coding a motion merge candidate using depth information may be installed in the video encoder 100 or the video decoder 200 as a component thereof. In another example, each of the components of the device 300 for coding a motion merge candidate using depth information or a program for implementing the operation of each of the components may be included in the existing components of the video encoder 100, such as the prediction unit 110, the adder 180, the encoding unit 150, and the like, or may be included in the existing components of the video decoder 200, such as the prediction unit 250, the adder 240, the decoding unit 210, and the like.

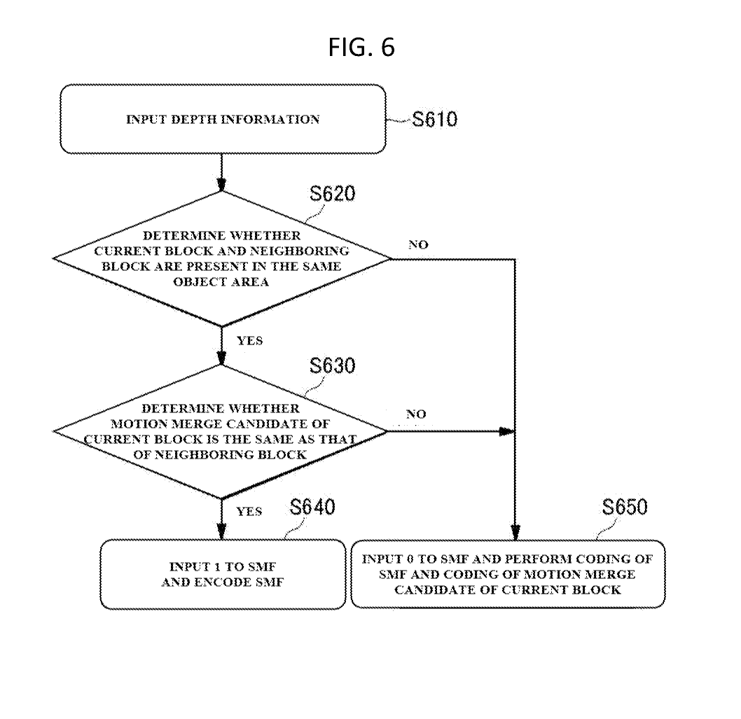

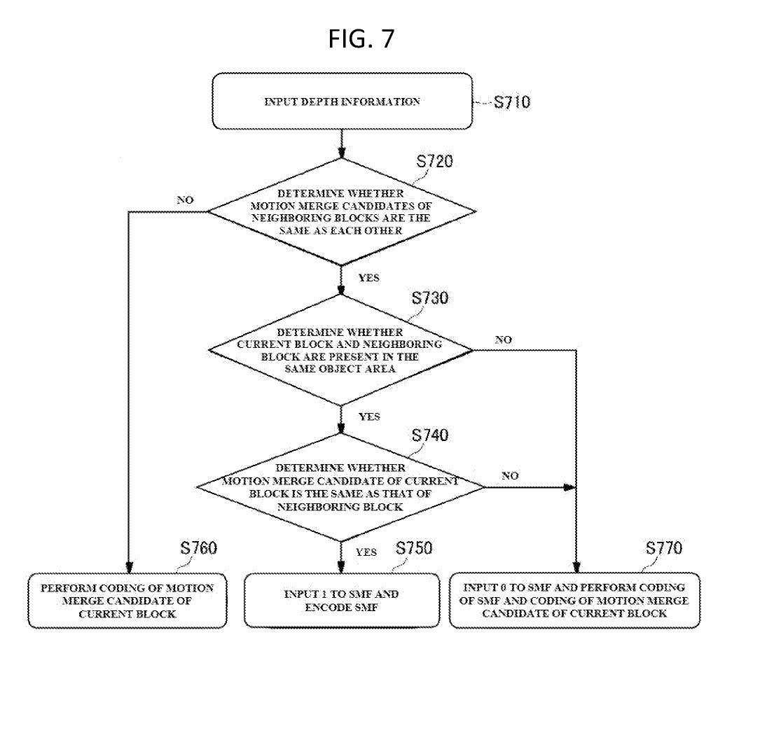

Hereinafter, a method for coding a motion merge candidate using depth information according to an embodiment of the present invention is described in detail with reference to FIG. 6 and FIG. 7.

FIG. 6 is a flowchart of a method for coding a motion merge candidate using depth information according to an embodiment of the present invention.

Referring to FIG. 6, in the method for coding a motion merge candidate using depth information according to an embodiment of the present invention, a first condition, corresponding to whether the current block and a neighboring block, which is spatially adjacent to the current block, are present in the same object area, is determined at step S620. Here, the first condition may be determined using depth information.

Then, in the method for coding a motion merge candidate using depth information, a second condition, corresponding to whether the motion merge candidate of the current block is the same as the motion merge candidate of the neighboring block, is determined at step S630.

In the method for coding a motion merge candidate using depth information, when the first condition and the second condition are satisfied, flag information representing that the motion merge candidate of the current block is the same as the motion merge candidate of the neighboring block may be set at step S640, rather than coding the motion merge candidate of the current block.

For example, in the method for coding a motion merge candidate using depth information according to an embodiment of the present invention, when the current block and the neighboring block are included in the same object area and when the motion merge candidate of the current block is the same as the motion merge candidate of the neighboring block, coding of the motion merge candidate for the current block is not performed, but same_merge_flag may be set to 1 in the flag information.

In the method for coding a motion merge candidate using depth information according to an embodiment of the present invention, an object area is determined based on depth information, and coding of at least one of a motion merge candidate and flag information is performed based on the result of the determination, whereby encoding and decoding efficiency may be improved.

In a method for coding a motion merge candidate using depth information according to another embodiment of the present invention, when the first condition or the second condition is not satisfied, flag information representing that the current block and the neighboring block are not present in the same object area or that the motion merge candidate of the current block is not the same as that of the neighboring block is set and output, and the motion merge candidate of the current block may be coded at step S650.

For example, in the method for coding a motion merge candidate using depth information, same_merge_flag may be set to 0 in the flag information to represent that the current block and the neighboring block are not present in the same object area or that the motion merge candidate of the current block is not the same as that of the neighboring block. Also, in the method for coding a motion merge candidate using depth information, the motion merge candidate of the current block may be coded.

Here, in the method for coding a motion merge candidate using depth information, the first condition, corresponding to whether the current block and a neighboring block, which is spatially adjacent to the current block, are present in the same object area, may be determined. Here, the determination using the depth information (S620) may be configured to analyze depth information acquired using a depth camera, to perform labeling of the object area in which the current block is present and labeling of the object area in which the neighboring block is present (not illustrated), and to determine the first condition based on the labeling.

FIG. 7 is a flowchart of a method for coding a motion merge candidate using depth information according to another embodiment of the present invention.

Referring to FIG. 7, in the method for coding a motion merge candidate using depth information according to another embodiment of the present invention, a first condition, corresponding to whether the current block and a neighboring block, which is spatially adjacent to the current block, are present in the same object area, may be determined at step S730. Here, the first condition may be determined using depth information.

Then, in the method for coding a motion merge candidate using depth information, a second condition, corresponding to whether the motion merge candidate of the current block is the same as the motion merge candidate of the neighboring block, is determined at step S740.

Also, in the method for coding a motion merge candidate using depth information, when the first condition and the second condition are satisfied, coding of flag information, representing that the motion merge candidate of the current block is the same as that of the neighboring block, may be performed at step S750, rather than coding the motion merge candidate of the current block.

Additionally, in the method for coding a motion merge candidate using depth information according to another embodiment of the present invention, a third condition, corresponding to whether the motion merge candidate of a first neighboring block is the same as that of a second neighboring block, may be determined at step S720, given that the first neighboring block and the second neighboring block are adjacent to the current block.

Here, in the method for coding a motion merge candidate using depth information, when the third condition is satisfied, the first condition and the second condition are determined again. In the method for coding a motion merge candidate using depth information, when the first, second, and third conditions are satisfied, the flag information representing that the motion merge candidate of the current block is the same as the motion merge candidate of the neighboring block may be set at step S750, rather than coding of the motion merge candidate of the current block.

For example, when the current block and the neighboring block are included in the same object area and when the motion merge candidate of the current block is the same as the motion merge candidate of the neighboring block, coding of the motion merge candidate for the current block is not performed, but same_merge_flag may be set to 1 in the flag information.

Here, the first neighboring block may be the upper block relative to the current block and the second neighboring block may be the left block relative to the current block. Also, at least one of the first neighboring block and the second neighboring block may be a skip block.

Also, in the method for coding a motion merge candidate using depth information according to a further embodiment of the present invention, when the third condition is not satisfied, coding of the motion merge candidate of the current block may be performed at step S760.

Further, in the method for coding a motion merge candidate using depth information according to a further embodiment of the present invention, when the first condition or the second condition is not satisfied, same_merge_flag is coded to 0 in the flag information that represents that the current block and the neighboring block are not present in the same object area or that the motion merge candidate of the current block is not the same as that of the neighboring block, and the motion merge candidate of the current block may be coded at step S570.

The components included in embodiments of the present invention are not limited to software or hardware, and may be configured to be stored in addressable storage media and to execute on one or more processors.

Therefore, as an example, the components may include components such as software components, object-oriented software components, class components, and task components, processes, functions, attributes, procedures, subroutines, segments of program code, drivers, firmware, microcode, circuitry, data, databases, data structures, tables, arrays, and variables.

The components and functionality provided in the corresponding components may be combined into fewer components, or may be further separated into additional components.

The embodiments of the present invention may also be implemented in the form of storage media including instructions that are executed by a computer, such as program modules executed by the computer. The computer-readable media may be arbitrary available media that can be accessed by the computer, and may include all volatile and nonvolatile media and removable and non-removable media. Further, the computer-readable media may include all computer storage media and communications media. The computer-storage media may include all volatile and nonvolatile media and removable and non-removable media, which are implemented using any method or technology for storing information, such as computer-readable instructions, data structures, program modules or additional data. The communications media typically include transmission media for computer-readable instructions, data structures, program modules or additional data for modulated data signals, such as carrier waves, or additional transmission mechanisms, and may include arbitrary information delivery media.

The above-described method and device for coding a motion merge candidate using depth information according to the present invention can be implemented as computer-readable code in computer-readable storage media. The computer-readable storage media include all types of storage media in which data that can be interpreted by a computer system is stored. Examples of the computer-readable storage media may include Read-Only Memory (ROM), Random-Access Memory (RAM), magnetic tape, a magnetic disk, flash memory, an optical data storage device, etc. Further, the computer-readable storage media may be distributed across computer systems connected through a computer communication network, and may be stored and executed as code that is readable in a distributed manner.

Although the method and system of the present invention have been described in relation to specific embodiments, some or all of the components or operations thereof may be implemented using a computer system that has general-purpose hardware architecture.

The description of the present invention is intended for illustration, and those skilled in the art will appreciate that the present invention can be easily modified in other detailed forms without changing the technical spirit or essential features of the present invention. Therefore, the above-described embodiments should be understood as being exemplary rather than restrictive. For example, each component described as a single component may be distributed and practiced, and similarly, components described as being distributed may also be practiced in an integrated form.

The scope of the present invention should be defined by the accompanying claims rather than by the detailed description, and all changes or modifications derived from the meanings and scopes of the claims and equivalents thereof should be construed as being included in the scope of the present invention.

1. A method for coding a motion merge candidate using depth information, comprising:
(a) determining a first condition corresponding to whether a current block and a neighboring block, which is spatially adjacent to the current block, are present in an identical object area, the first condition being determined using the depth information;
(b) determining a second condition corresponding to whether a motion merge candidate of the current block is identical to a motion merge candidate of the neighboring block; and
(c) when the first condition and the second condition are satisfied, coding flag information that represents that the motion merge candidate of the current block is identical to the motion merge candidate of the neighboring block, rather than coding the motion merge candidate of the current block.

2. The method of claim 1, further comprising
(d) determining a third condition corresponding to whether a motion merge candidate of a first neighboring block is identical to a motion merge candidate of a second neighboring block, the first neighboring block and the second neighboring block being adjacent to the current block,
wherein:
when the third condition is satisfied, the first condition and the second condition are determined, and
when the first condition, the second condition, and the third condition are satisfied, (c) is configured to perform coding of the flag information.

3. The method of claim 2, wherein the first neighboring block is an upper block relative to the current block, and the second neighboring block is a left block relative to the current block.

4. The method of claim 2, wherein at least one of the first neighboring block and the second neighboring block is a skip block.

5. The method of claim 2, further comprising
(e) when the third condition is not satisfied, coding the motion merge candidate of the current block.

6. The method of claim 1, further comprising
(f) when the first condition or the second condition is not satisfied, coding the flag information to 0 and coding the motion merge candidate of the current block.

7. The method of claim 1, wherein (a) comprises
performing labeling of an object area in which the current block is present and labeling of an object area in which the neighboring block is present by analyzing depth information acquired using a depth camera, and
(a) is configured to determine the first condition based on the labeling.

8. A device for coding a motion merge candidate using depth information, comprising:
a depth information extraction unit for extracting depth information from a current block and a neighboring block, which is adjacent to the current block;
an object area comparison unit for determining a first condition corresponding to whether the current block and the neighboring block are present in an identical object area based on the depth information extracted by the depth information extraction unit;
a motion merge candidate comparison unit for determining a second condition corresponding to whether a motion merge candidate of the current block is identical to a motion merge candidate of the neighboring block;
a flag information generation unit for generating flag information based on at least one of a result of the determination by the object area comparison unit and a result of the determination by the motion merge candidate comparison unit; and
a coding unit for coding at least one of the motion merge candidate of the current block and the flag information.

9. The device of claim 8, wherein the object area comparison unit is configured to:
perform labeling of an object area in which the current block is present and labeling of an object area in which the neighboring block is present by analyzing depth information acquired using a depth camera, and
determine the first condition based on the labeling.

10. The device of claim 8, wherein the motion merge candidate comparison unit determines a third condition corresponding to whether a motion merge candidate of a first neighboring block is identical to a motion merge candidate of a second neighboring block, the first neighboring block and the second neighboring block being adjacent to the current block.

11. The device of claim 10, wherein the first neighboring block is an upper block relative to the current block, and the second neighboring block is a left block relative to the current block.

12. The device of claim 10, wherein at least one of the first neighboring block and the second neighboring block is a skip block.

13. The device of claim 8, wherein when the first condition and the second condition are satisfied, the coding unit performs coding of flag information that represents that the motion merge candidate of the current block is identical to the motion merge candidate of the neighboring block, rather than coding the motion merge candidate of the current block.

14. The device of claim 8, wherein when the first condition or the second condition is not satisfied, the coding unit codes the flag information to 0 and codes the motion merge candidate of the current block.

15. The device of claim 10, wherein:
when the third condition is satisfied, the object area comparison unit determines the first condition and the motion merge candidate comparison unit determines the second condition, and
when the first condition, the second condition, and the third condition are satisfied, the coding unit performs coding of flag information that represents that the motion merge candidate of the current block is identical to the motion merge candidate of the neighboring block, rather than coding the motion merge candidate of the current block.

16. The device of claim 10, wherein when the third condition is not satisfied, the coding unit performs coding of the motion merge candidate of the current block.
